(19) United States
(12) Patent Application Publication
(10) Pub. No.: US 2022/0220790 A1
(43) Pub. Date: Jul. 14, 2022

(54) STRUCTURE ACCESS SYSTEM

(71) Applicant: DJR FARMS LLC, Tremonton, UT (US)

(72) Inventors: Dee Loy RUPP, Tremonton, UT (US); Scott FUHRIMAN, Malad, ID (US); Jerry RHODES, Garland, UT (US)

(73) Assignee: DJR FARMS LLC, Tremonton, UT (US)

(21) Appl. No.: 17/573,083

(22) Filed: Jan. 11, 2022

Related U.S. Application Data
(60) Provisional application No. 63/137,613, filed on Jan. 14, 2021.

(51) Int. Cl. E05F 11/20; B65D 90/62; B65D 90/66

(52) U.S. Cl. CPC E05F 11/20; B65D 90/623; B65D 90/66; E05Y 2900/604; E05Y 2201/686; E05Y 2800/70; E05Y 2201/626

(57) ABSTRACT

A structure access system that allows a user at ground level to open and close a traditionally ladder-accessed entrance on the top of a structure like a silo through a pivotable lever-controlled linkage that includes elongate members joined by a rocker arm configured to translate vertical movement into angled movement to open and close the top entrance.

### RELATED APPLICATION

This application is the non-provisional, utility application of provisional application U.S. App. No. 63/137,613, filed on Jan. 14, 2021, and claims priority thereto.

### BACKGROUND OF THE INVENTION

Many types of tall structures require top entrance. One example of such a structure is a silo. Silos are used in agriculture to store grain or silage, but they may also be used in many contexts to store any number of other products. Many kinds of silos are filled with product at a top entrance using a long, ground-based spiral auger. Such filling requires that a user climb the silo to open the top entrance and position the auger. When this process is done, the user must again climb the silo to close the top entrance.

The operations described above may present several undesirable conditions. First, the mere fact that a user is required to climb up and down a tall structure to perform operations may be time consuming and inefficient. Second, climbing a tall structure may be difficult for many users. Third, a user that is required to scale a tall structure is exposed to falling danger, bodily injury, or even death.

Despite the long-use of tall structures such as silos, little has been invented to mitigate the undesirable conditions described. Designs continue to require that a user scale the structure to open and close a top entrance and to perform filling operations. What is needed is a reliable structure access system that allows a user to open and close a top entrance and to perform filling operations without having to climb the structure. Such a system would increase efficiency and ease of operation and reduce the risk of bodily injury or death.

### SUMMARY OF THE INVENTION

In accordance with the above, a new and innovative structure access system is provided for structure access above a user's ground-standing reach. Specifically, the structure access system allows a user at ground level to open and close an access on a top of a structure—typically one for storage of bulk materials like a silo—and includes: a pivotable lever; a first elongate member with first and second ends, the first elongate member pivotally attached to the lever at the first elongate member first end; a rocker arm pivotally attached to the first elongate member second end; a second elongate member with first and second ends, the second elongate member pivotally attached to the rocker arm at the second elongate member first end; and a top entrance mount to which the second elongate member is pivotally attached at the second elongate member second end.

These and other aspects of the present invention will become more fully apparent from the following description and appended claim, or they may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a side view of one embodiment of a structure access system in a first position.

FIG. 2 is a side view of a lower portion of one embodiment of a structure access system.

FIG. 3 is a side view of a middle portion of one embodiment of a structure access system.

FIG. 4 is a side view of an upper portion of one embodiment of a structure access system.

FIG. 5 is a side view of one embodiment of a structure access system in a second position.

### DETAILED DESCRIPTION OF THE ILLUSTRATED EMBODIMENT

The present invention in its various embodiments, some of which are depicted in the figures herein, is a structure access system.

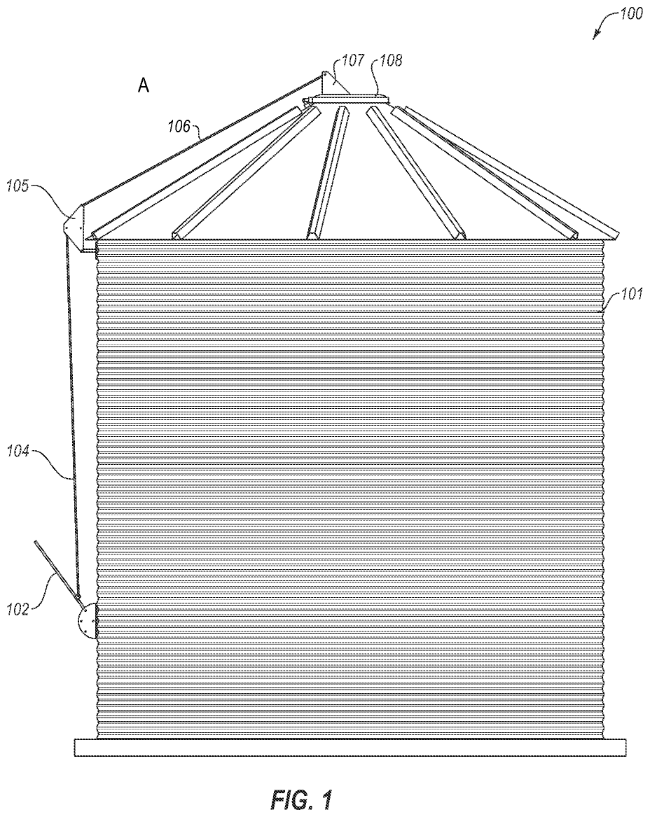

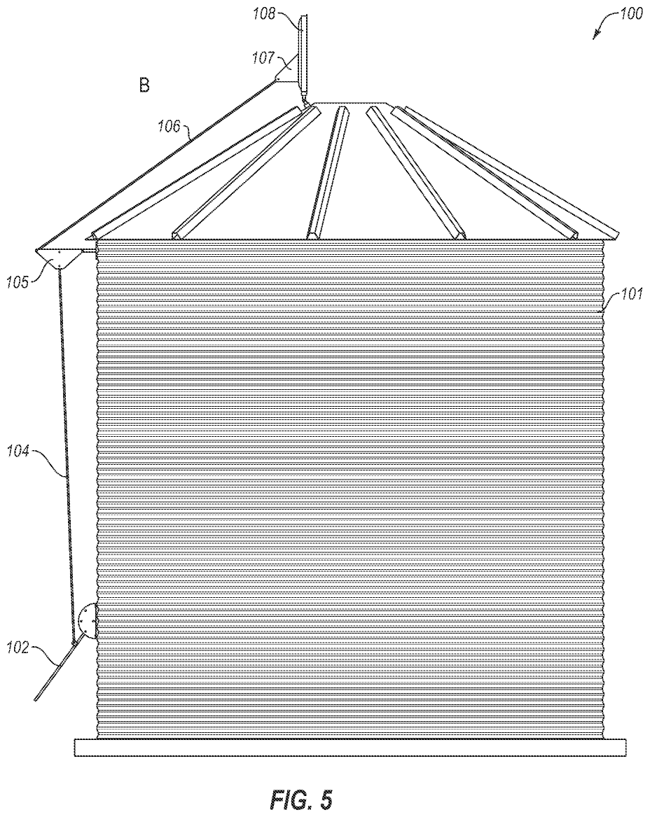

Referring now to FIG. 1, one embodiment of an exemplary structure access system 100 is shown. Structure access system 100 is shown in a silo structure 101 environment with a top entrance 108, although many other structure types needing top access may also be employed. In certain embodiments, silo structure 101 and/or top entrance 108 may be included in the embodiment. Structure access system 100 is shown in a closed position A, or a position wherein the top entrance 108 is closed (see also FIG. 5 showing the system in open position B wherein the top entrance 108 is open). The system 100 includes a pivotable lever 102 for opening and closing the top entrance 108 by a user who is at or adjacent to ground level. A first elongate member 104 with first and second ends is pivotally attached to the pivotable lever 102 at the first elongate member first end. A rocker arm 105 is pivotally attached to the silo 101 and first elongate member second end. A second elongate member 106 with first and second ends is pivotally attached to the rocker arm 105 at the second elongate member first end. The second elongate member 106 is pivotally attached at the second elongate member second end to a top entrance mount 107 that is secured to the top entrance 108.

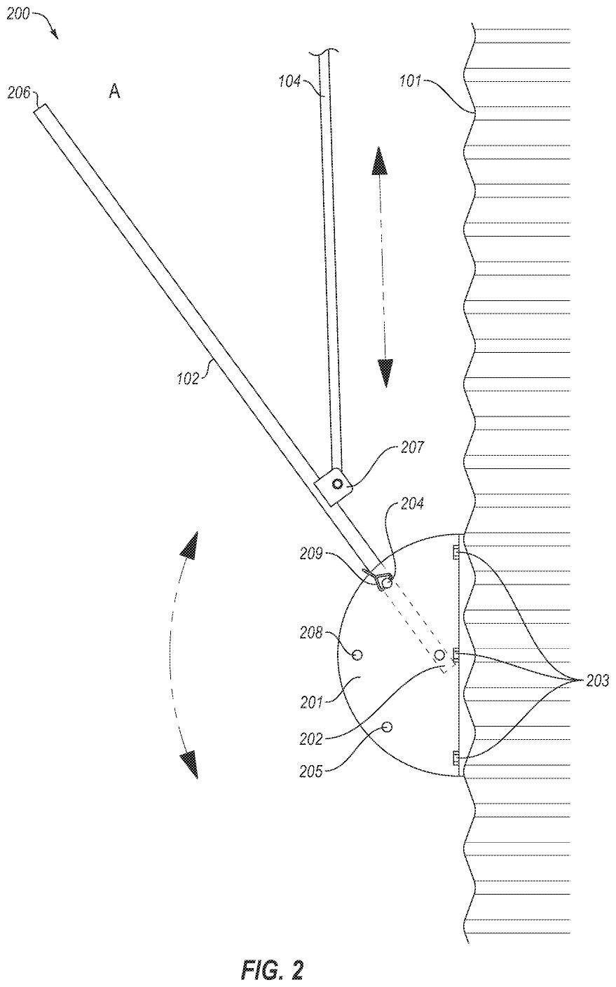

Referring now to FIG. 2, a lower portion 200 of one embodiment of a structure access system 100 is shown. Pivotable lever 102 is preferably positioned within the reach of a user at ground level. Pivotable lever 102 is attached to a silo structure 101 through a mounting plate 201 adjacent to a pivotable lever first end 202. Pivotable lever 102 has a first elongate member mount 207 between first 202 and second 206 pivotable lever ends for pivotally attaching the first elongate member 104 at a first elongate member first end. In the illustrated embodiment, first elongate member 104 is generally positioned parallel to vertical axis of the silo structure 101. Elongate member 104 is typically a metal rod, although it may be made of other materials without departing from the purpose and scope of the invention.

Mounting plate 201 may be comprised of two or more opposing plates bounding the pivotable lever 102. In the illustrated embodiment, pivotable lever 102 moves in a vertical plane along an axis that is perpendicular to the pivot. Mounting plate 201 may have a plurality of fasteners 203 for affixing the mounting plate 201 to the silo structure 101. Mounting plate 201 may have one or more spacers and/or stops 204, 205 for facilitating or controlling the travel of the pivotable lever 102. In the illustrated embodiment, stops 204, 205 lock the pivotable lever 102 with a removable pin and clip. In the illustrated embodiment, the mounting plate 201 may be approximately 12.5 inches high, 6.25 inches in depth, and 4 inches in width, with around 10.5 inches of lever travel, although these measurements may vary without departing from the purpose and scope of the invention.

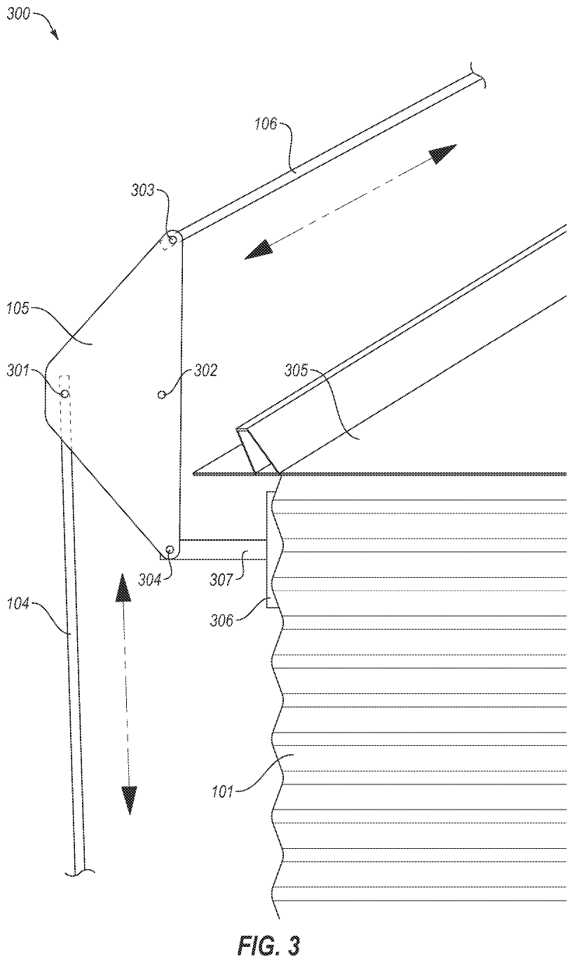

Referring now to FIG. 3, a middle portion 300 of one embodiment of a structure access system 100 is shown. First elongate member 104 attaches to a rocker arm 105 at a first elongate member second end. Rocker arm 105 is preferably attached at a position adjacent to the top of a side of the silo structure 101, and, as with mounting plate 201, it may be comprised of two or more opposing plates. Second elongate member 106 with first and second ends is pivotally attached to the rocker arm 105 at the second elongate member first end. As with first elongate member 104, second elongate member is typically a metal rod, although it may be made of other materials without departing from the purpose and scope of the invention.

Rocker arm 105 is configured to translate vertical movement from first elongate member 104 (typically initiated by movement of the pivotable lever 102) to a more horizontal angle. This is accomplished by the unique configuration of the rocker arm 105 and its various connections to other components. More specifically, rocker arm may be configured as a rounded isosceles triangle with connections adjacent each of its base and vertex angles. A first connection 304 adjacent a first base angle pivotally attaches the rocker arm 105 to the silo structure 101. Entire rocker arm 105 is pivotable about this first connection 304. A second connection 301 adjacent a vertex angle pivotally attaches the rocker arm 105 to the first elongate member 104. A third connection 303 adjacent a second base angle pivotally attaches the rocker arm 105 to the second elongate member 106. In the illustrated embodiment, the rocker arm may be approximately 14 inches long at its longest edge and 8 inches in depth, although these measurements may vary without departing from the purpose and scope of the invention.

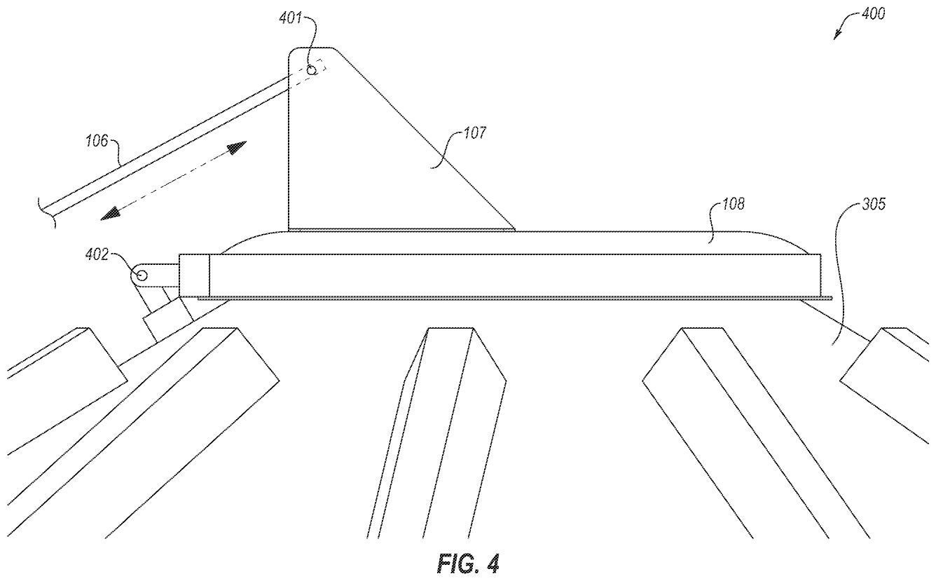

Referring now to FIG. 4, an upper portion 400 of one embodiment of a structure access system 100 is shown. Second elongate member 106 is pivotally attached to top entrance mount 107 at the second elongate member second end. In the illustrated embodiment, the top entrance 107 is approximately 8 inches high and 10 inches long at its longest edge. Second elongate member 106 attaches to an upper location of the top entrance mount 107 so that there is sufficient leverage from movement at the horizontal angle to open and/or close the top entrance 108. In various embodiments, the invention may also include a hinge 402 adjacent the top entrance.

Referring now to FIGS. 1 and 5, in the illustrated embodiment, pivotable lever 102 is in an upwards position when the top entrance 108 is closed. As a user pulls pivotable lever 102 downwards, first elongate member 104 moves downward and rocker arm 105 translates this movement along a more horizontal angle, pulling the top entrance mount 107 to open the top entrance 108. In FIG. 5, the structure access system 100 is shown in an open position B. In various embodiments locking means may be used to releasably maintain structure access system 100 in closed, open, or intermediate positions.

Thus configured, a reliable structure access system is provided that allows a user to open and close a top entrance and to perform filling operations without having to climb the structure, thereby increasing efficiency and ease of operation and reducing the risk of bodily injury or death.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A structure access system comprising:
a pivotable lever;
a first elongate member with first and second ends, the first elongate member pivotally attached to the pivotable lever at the first elongate member first end;
a rocker arm pivotally attached to the first elongate member second end;
a second elongate member with first and second ends, the second elongate member pivotally attached to the rocker arm at the second member first end; and
an entrance mount to which the second elongate member is pivotally attached at the second member second end, the entrance mount attached to a structure entrance that is above a user's ground-standing reach.

2. The structure access system of claim 1, the system further having a first position for opening an entrance to a structure for storing bulk materials and a second position for closing an entrance to a structure for storing bulk material.

3. The structure access system of claim 1, wherein the first elongate member is rigid.

4. The structure access system of claim 1, wherein the second elongate member is rigid.

5. The structure access system of claim 1, the rocker arm generally isosceles triangle-shaped with a first base angle, second base angle, and a vertex angle, the rocker arm further having
a first connection adjacent to the first base angle that pivotally attaches the rocker arm to a structure for storing bulk material;
a second connection adjacent to the vertex angle that pivotally attaches the rocker arm to the first elongate member; and
a third connection adjacent to the second base angle that pivotally attaches the rocker arm to the second elongate member.

6. The structure access system of claim 5, the rocker arm pivotable about the first connection.

7. The structure access system of claim 5, the rocker arm configured to translate first elongate member vertical movement to an angle that is less than 90 degrees.

8. The structure access system of claim 1, wherein the system is configured as an aftermarket system for application to an existing structure for storing bulk material.

9. A structure access system comprising:
a pivotable lever;
a first rigid elongate member with first and second ends, the first rigid elongate member pivotally attached to the pivotable lever at the first rigid elongate member first end;
a rocker arm pivotally attached to the first rigid elongate member second end;
a second rigid elongate member with first and second ends, the second rigid elongate member pivotally attached to the rocker arm at the second rigid elongate member first end; and
a top entrance mount to which the second rigid elongate member is pivotally attached at the second member second end, the top entrance mount attached to a structure entrance that is above a user's ground-standing reach; and
wherein the rocker arm is generally isosceles triangle-shaped with a first base angle, second base angle, and a vertex angle, the rocker arm further having
a first connection adjacent to the first base angle that pivotally attaches the rocker arm to a structure for storing bulk material;
a second connection adjacent to the vertex angle that pivotally attaches the rocker arm to the first rigid elongate member; and
a third connection adjacent to the second base angle that pivotally attaches the rocker arm to the second rigid elongate member.

10. The structure access system of claim 9, further comprising a structure for storing bulk material.

11. The structure access system of claim 9, the pivotable lever having a first position for opening an entrance to a structure for storing bulk material and a second position for closing the entrance to the structure for storing bulk material.

12. The structure access system of claim 9, the rocker arm pivotable about the first connection.

13. The structure access system of claim 9, the rocker arm configured to translate first rigid elongate member vertical movement to an angle that is less than 90 degrees.

14. The structure access system of claim 9, wherein the system is configured as an aftermarket system for application to an existing structure for storing bulk material.

15. An aftermarket structure access system configured to provide access to a structure for storing bulk material comprising:
a pivotable lever having a first position for opening an entrance to the structure for storing bulk materials and a second position for closing the entrance to the structure for storing bulk material, the entrance above a user's ground-standing reach;
a first rigid elongate member with first and second ends, the first rigid elongate member pivotally attached to the pivotable lever at the first rigid elongate member first end;
a rocker arm pivotally attached to the first rigid elongate member second end;
a second rigid elongate member with first and second ends, the second rigid elongate member pivotally attached to the rocker arm at the second rigid elongate member first end;
a top access mount to which the second rigid elongate member is pivotally attached at the second rigid elongate member second end, the top access mount attached to the entrance;
wherein the rocker arm is generally isosceles triangle-shaped with a first base angle, second base angle, and a vertex angle, the rocker arm further having
a first connection adjacent to the first base angle that pivotally attaches the rocker arm to the structure for storing bulk materials, the rocker arm pivotable about the first connection;
a second connection adjacent to the vertex angle that pivotally attaches the rocker arm to the first rigid elongate member; and
a third connection adjacent to the second base angle that pivotally attaches the rocker arm to the second rigid elongate member; the rocker arm configured to translate vertical movement from the first rigid elongate member to an angle that is less than 90 degrees.
